(19) United States
(12) Patent Application Publication
(10) Pub. No.: US 2015/0098608 A1
(43) Pub. Date: Apr. 9, 2015

(54) MANAGEMENT OF ELECTRONIC RACKS

(71) Applicant: International Business Machines Corporation, Armonk, NY (US)

(72) Inventors: Gregory R. Hintermeister, Rochester, MN (US); Carlos Santana, Durham, NC (US)

(73) Assignee: International Business Machines Corporation, Armonk, NY (US)

(21) Appl. No.: 14/048,525

(22) Filed: Oct. 8, 2013

(51) Int. Cl. G06K 9/00; H04N 7/18

(52) U.S. Cl. CPC G06K 9/0055; H04N 7/183
USPC 382/103

(57) ABSTRACT

Computer program product and method for determining a location and identity of an electronic rack by a remote electronic device is disclosed. The method may include capturing an image of the electronic rack with a camera attached to the remote electronic device. The method may further include determining a visual identifying trait of the captured image of the electronic rack. The method may further include comparing the visual identifying trait of the captured image of the electronic rack to a known identifying trait of a known electronic rack identified in an inventory. The method may include identifying the electronic rack based on the comparison of the visual identifying trait of the captured image to the known identified trait. The method may further include determining a location of the electronic rack by the remote electronic device. The method may further include recording the location of the identified electronic rack.

### TECHNICAL FIELD

Embodiments described herein generally relate to electronic racks, and more specifically, to determining electronic rack identity and location.

### BACKGROUND

Modern computer systems, such as servers, are often contained in electronic racks. The electronic racks may be housed together, with rooms containing large numbers of electronic racks not uncommon. Electronic racks may be housed in the same room for efficiency in wiring, cooling, and security. The ability to find and identify individual electronic racks or components that are part of the electronic rack in a location may be difficult. Similarity in electronic rack and component sizes, shapes, and layout may make quick identification or location difficult and time consuming for maintenance, upgrading, or inventorying.

### SUMMARY

Embodiments of the disclosure provide methods and computer program products for determining a location and identity of an electronic rack by a remote electronic device. The method may include capturing an image of the electronic rack with a camera attached to the remote electronic device. The method may further include determining a visual identifying trait of the captured image of the electronic rack. The method may further include comparing the visual identifying trait of the captured image of the electronic rack to a known identifying trait of a known electronic rack identified in an inventory. The method may include identifying the electronic rack based on the comparison of the visual identifying trait of the captured image to the known identified trait. The method may further include determining a location of the electronic rack by the remote electronic device. The method may further include recording the location of the identified electronic rack.

An embodiment directed to a computer program product for determining a location and identity of an electronic rack by a remote electronic device is disclosed. The computer program product may include capturing an image of the electronic rack with a camera attached to the remote electronic device. The computer program product may further include determining a visual identifying trait of the captured image of the electronic rack. The computer program product may further include comparing the visual identifying trait of the captured image of the electronic rack to a known identifying trait of a known electronic rack identified in an inventory. The computer program product may include identifying the electronic rack based on the comparison of the visual identifying trait of the captured image to the known identified trait. The computer program product may further include determining a location of the electronic rack by the remote electronic device. The computer program product may further include recording the location of the identified electronic rack.

### BRIEF DESCRIPTION OF THE DRAWINGS

Features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments may be practiced and to further enable those of skill in the art to practice the embodiments. It is also to be understood that the descriptions of the embodiments are provided by way of example only, and are not intended to limit the scope of the embodiments as claimed. In the figures of the accompanying drawings, like reference numerals may refer to similar elements or steps.

FIG. 1 depicts a high-level block diagram of an exemplary system according to an embodiment of the invention.

FIG. 2 depicts a high-level block diagram of an exemplary captured image of an electronic rack, for implementing, according to an embodiment.

FIG. 3 is a flowchart illustrating a method for determining an identity and location of an electronic rack by a remote electronic device, according to an embodiment.

FIG. 4 is a flowchart illustrating a method for determining a visually identifying trait of an electronic rack in a captured image, according to an embodiment.

FIG. 5 is a flowchart illustrating a method for comparing and identifying an electronic rack captured in an image, according to an embodiment.

FIG. 6 is a flowchart illustrating a method for determining an identity and location of a component by a remote electronic device, according to an embodiment.

### DETAILED DESCRIPTION

Electronic racks may consist of the combination of a rack for housing components and the components contained in the rack. The components may include, but are not limited to, servers, blades, electronic storage systems, or networking hardware. In some instances, multiple electronic racks may be kept in a single room, center, or data center. Knowing the location of, or being able to quickly identify, a specific electronic rack may improve the management of the center. It may currently be cumbersome for users to manage the electronic racks as they may need to memorize the electronic rack layout of the data center or manually update information about the electronic racks so they may be easily located. Embodiments presented may allow for improved efficiency in locating electronic racks, identifying specific electronic racks or components, and managing data centers.

In various embodiments presented an electronic device with an attached camera may be used to capture an image of an electronic rack. In various embodiments, this may include, but is not limited to, mobile phones, tablets, handheld computer devices, laptops, digital cameras, or video devices. An identifying trait of the electronic rack may be determined and compared with a known identifying trait of a known rack to identify the electronic rack. In various embodiments, this may include shape, size, components, markings, or other visually differentiable details. Similarly, embodiments may be used to identify components of the electronic rack using visually differentiable details such as, but not limited to, shape, size, markings, controls, or interfaces. The identification of traits and the determination and comparison of traits is discussed in more detail below. Further, the location of the electronic rack and component may be determined so that the identity and location of the electronic rack and component may be recorded for use later or by available applications or systems. The determination of the electronic rack and component location is discussed in more detail below. In various embodiments, the recorded location and identification may be outputted to a user to identify the electronic rack or specific components of the electronic rack, to guide a user to the rack or specific components of the electronic rack, or to update or manage the inventory and layout of the data center. It is contemplated that other uses for the recorded location and identification of the electronic rack may be used and be in the scope of the disclosure.

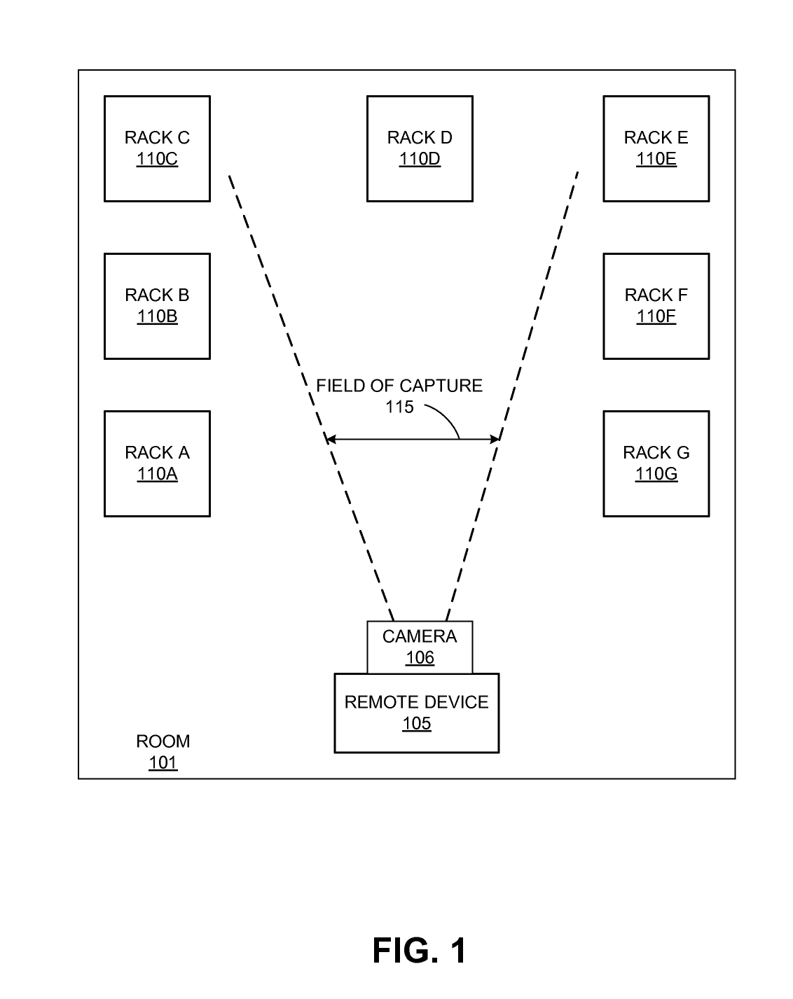

FIG. 1 depicts a high-level block diagram of an exemplary system for implementing an embodiment of the invention. In the illustrated embodiment, electronic racks 110A and component through 110G (generically referred to as 110) may be located in room 101. A remote electronic device 105 may also be in the room. The remote electronic device 105 may have a camera 106 attached. In various embodiments, the remote electronic device 105 may have camera 106 built in or it may be a separate device attached via a wired or wireless connection. In various embodiments, remote electronic device 105 may be a camera with components, features, or technology that may provide information for the identification and location of electronic racks. While the illustrated embodiment shows electronic device 105 and camera 106 in room 101 with electronic racks 110A through 110G it is contemplated that either the electronic device 105 or camera 106 may be outside of room 101. For example, the camera 106 may capture the image through an opening such as a doorway or window or the walls of the room may be translucent allow for image capture through them.

In various embodiments, the camera 106 may have a field of capture 115. Field of capture 115 may be the area and entities captured by an image if the camera takes a picture. In various embodiments, field of capture 115 may be changed by moving the camera, the remote electronic device, or by changing/moving parts of the camera. For example, the lens may be changed, the setting for the camera may be changed, or the zoom may be changed.

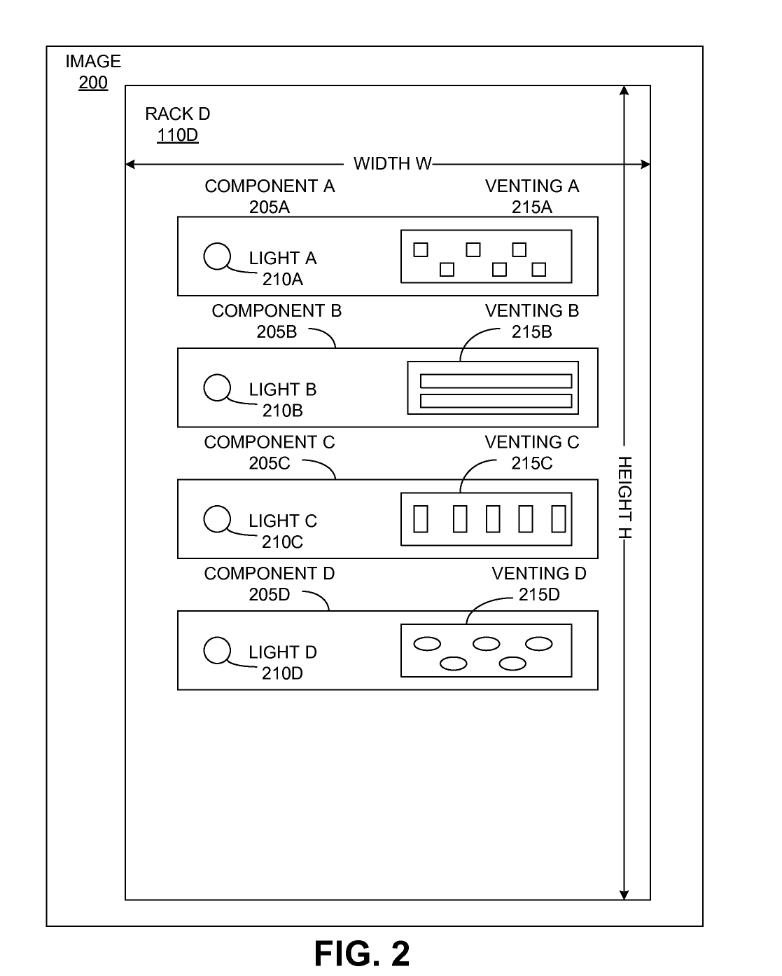

FIG. 2 depicts a high-level block diagram of an exemplary captured image 200 of electronic rack D 110D, for implementing an embodiment of the invention. In the illustrated example, electronic Rack D 110D is the only electronic rack captured in image 200. In various embodiments, the captured image 200 or series of captured images may include multiple electronic racks. In embodiments with multiple electronic racks in the captured image, a plurality of the electronic racks may be identified and located. In various embodiments, the electronic racks identified and located may be selected by a user, by location in the image, for example the most central rack, or clarity or focus in the image may be a selection criteria for identification. In various embodiments, the image may include other electronic racks or room features for identification and location of one or more of the electronic racks. For example, captured image 200 may be require to include electronic racks C through E, 110C through 110E, to aid in determining the location of electronic rack D 110D. In another example, the image 200 may be required to be taken from a doorway of room 101 so that the location of electronic rack D 110D may be determined. In various embodiments, a series of images, such as but not limited to, video recording may employ a scanning view or series of images of the area around electronic rack D to determine a location.

In the illustrated example, the front of Rack D 110D is captured in the image 200. In various other embodiments, side views, angled views, or multiple views may be employed for identification and location of the electronic rack. In the illustrated example, a variety of possible visually identifying traits are illustrated. Electronic Rack D 110D may have a height H and a width W. Electronic rack D may also include components A through D, 205A through 205D respectively. Components A through D may each have a light A through D, 210A through 210D respectively, and venting A through D, 215A through D respectively. In various embodiments, software available to the remote electronic device may select one or more of the possible visual identifying traits for identifying electronic rack D 110D. In various embodiments, the software may start with first identifying trait from the possible identifying traits and then use additional identifying traits from the possible identifying traits until identification is completed. Examples of other possible identifying traits that may exist or be used includes, but is not limited to, rack or component sizes, colors, shapes, jacks, connectors, logos, markings, or operations (described below).

For example, remote electronic device 105 may determine a first identifying trait of rack D 110D as the rack size using height H and width W. Height H and width W of rack D 110D may be compared to the heights and widths of identified electronic racks in an inventory available to remote electronic device 105, and electronic racks in the inventory with a different rack size may then be excluded. In various embodiments, the inventory of known electronic racks may be a database or list of electronic racks and identifying features available to remote electronic device 105. In various embodiments, the inventory may be stored in remote electronic device 105 or may be stored remotely but accessible to remote electronic device 105 through a network. In the example, the database available to remote electronic device 105 may include identifying traits for three hundred different electronic racks. In various embodiments, the number of racks and identifying traits is not limited to any specific number or threshold. In the example, the comparison of height H and width W of rack D 110D may reduce or limit the number of possible identified electronic racks electronic rack D 110D to twenty.

In the example, remote electronic device 105 may determine a second visually identifying trait of captured image 200 with which to compare and identify electronic rack D 110D. For example, remote electronic device 105 may use the components A through D to identify electronic rack D 110D. This may require determining, comparing, and identifying one or more components 205A through 205D in or of electronic rack D 110D. In various embodiments, the first visually identifying trait may result in identifying the electronic rack. In other embodiments, numerous determinations and comparisons of identifying traits may be required to identify the electronic rack.

In various embodiments, once the identity of electronic rack D 110D is determined, a similar identification of components within rack D may occur. Thus, the electronic device may employ captured image 200, or another captured image, to determine, compare, and identify one or more components in or on electronic rack D 110D. This may be used to confirm or update inventory, check for changes in electronic rack layout, or identify new resources. For example, electronic rack D 110D may be identified by using height H, width W, and component A 205A. The electronic device may then determine visual identifying traits for another or all remaining components B through D, 205B through 205D, and use the same technology to identify each component 205. In an example, component C 205C may not match the inventory for an identified rack 110D. In various embodiments, the remote electronic device may record the new components and where it is located in electronic rack D 110D. The record may be made available to other application or software of the remote electronic device or to other systems or software in communication with remote electronic device 105.

In various embodiments, changes in components may prevent the comparison of electronic rack 110 from exactly matching with a known electronic rack identified in an inventory. In some embodiments, the identification may be based off default, primary, or preferred visual identification traits. In other embodiments, the identification may be based off a majority of visual identification traits or a closest match system with known racks in the inventory.

In various embodiments, light A through D, 210A through 210D, may be used either individually or in groups as a visually identifying trait. In various embodiments, remote electronic component 105 may communicate with and control the light emitting capabilities of one or more of the lights 210. In various embodiments, the lights may be turned on, turned off, change color, or flashed in sequence so to create the visually identifying trait. In various embodiments, this may require multiple timed images or video images to be captured. In various embodiments, the lights 210A through 210D on the respective individual components 205A through 205D may be controlled so that individual components may be identified in a similar way.

In various embodiments, one of the components 205 of the electronic rack 110 may want to be identified and located of for recording by a user or application. This may be accomplished using similar means to identifying the electronic rack 110 described above. An identifying trait of the components may be determined as described above. The identifying trait may be compared to a known identifying trait for a known component identified in an inventory. This may include similar identifying traits as described for the electronic rack 110 and components above. For example, the use of flashing of lights 210A through 210D may again be used for component identification. Once identified, the components location may be determined. This may include, but is not limited to the slot, position, height, or placement of the component in the electronic rack 110. The location and identification of the component may be recorded once determined.

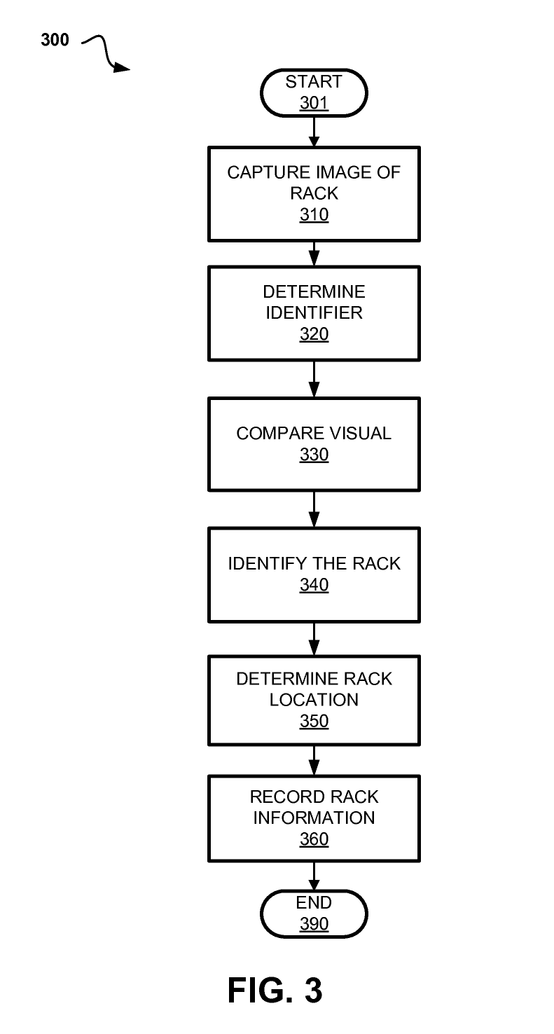

FIG. 3 is a flowchart illustrating a method 300 for determining an identity and location of an electronic rack, such as electronic rack D 110D in FIG. 2, by remote electronic device 105, according to an embodiment. Method 300 may start at block 301. In block 310, image 200 of electronic rack D 110D may be captured. As previously discussed, this may be done by a camera 106 that is part of or in communication with remote electronic device 105.

In block 320, a visually identifying trait may be determined for the captured image 200. This may be done by remote electronic device 105 or software available to remote electronic device 105 through a network and is discussed in greater detail below. In block 330, the previously determined visually identifying trait may be compared to a known identifying trait of a known electronic rack identified in the inventory. As previously mentioned, the inventory may be stored in remote electronic device 105 or accessible via a network. In block 340, electronic rack D 110D may be identified if the comparison between the visually identifying trait of the captured image 200 is determined to match the known identifying trait of a known electronic rack identified in the inventory. As previously mentioned, the match may not be 100% for the identification to occur and several iterations of the determination and comparing may be done before the identification is completed.

In block 350, method 300 may determine the location of the electronic rack D 110D. In various embodiments, the location may be determined using GPS systems in or available to remote electronic device 105. In other embodiments, the image may be analyzed for visual information of the racks location. This may include, but is not limited to, proximity to other known electronic racks, location markers or identifiers in the image or other images available. For example, remote electronic device 105 may use video recordings for capturing images. The video may be analyzed for location information and it may be found that the device was taken into a known room 101 and then turned left before captured image 200 was made. This is exemplary only and a variety of location information and sources is contemplated to be used without departing from the scope of embodiments of the invention.

In block 360, the identity and location of the electronic rack D 110D may be recorded. In various embodiments, this may be information updated, recorded, or modified in the inventory. In other embodiments, the location and identity of electronic rack D 110D may be recorded to a memory, either part of remote electronic device 105 or remote but available for access by remote electronic device 105. In other embodiments, the information may be recorded to or by an application, software, or database different from the inventory. Method 300 may end in block 390.

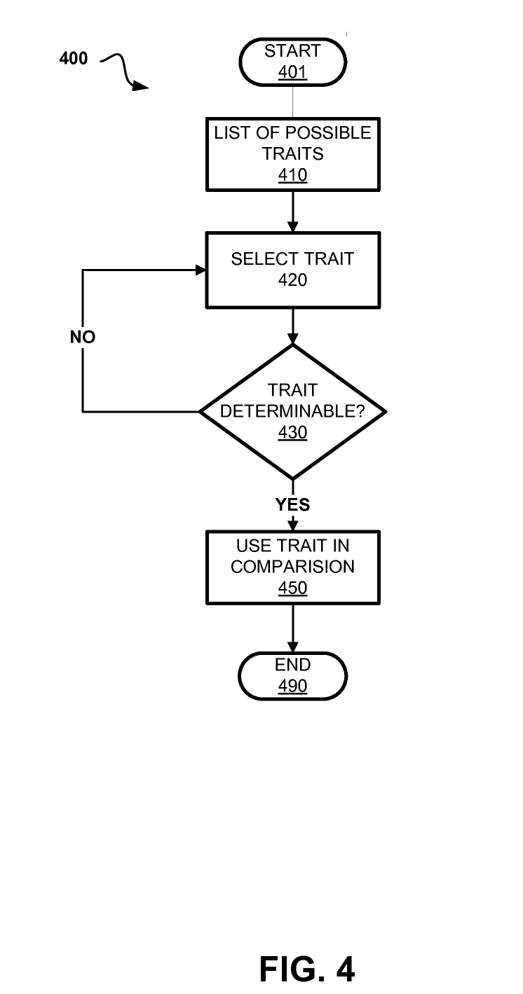

FIG. 4 is a flowchart illustrating a method 400 for determining a visually identifying trait of an electronic rack in a captured image, according to an embodiment. Method 400 may start in block 401. In block 410, a list of possible identifying traits may be created, reviewed, or selected. In various embodiments, the list of possible identifying traits may be derived from known identifying traits in the inventory containing the known electronic rack. Using the previously mentioned example, the inventory may include identifying traits for three hundred known electronic racks. For each electronic rack the inventory may include, but is not limited to, identifying traits such as height, width, logos, color, or components. In various embodiments, the list of possible identifying traits may be derived from the inventory. In other embodiments, the list of possible identifying traits may be provided or derived by other lists, databases, software, or applications.

In block 420, a possible identifying trait may be selected. The selection may be based upon, but not limited to, list order, user preference, or a prioritization of possible identifying traits. With the possible identifying trait selected, method 400 may analyze the captured image, such as captured image 200, to find if the trait is determinable. If the trait is not determinable in block 430 then method 400 may return to block 420 and select another possible identifying trait. For example, in block 420 the possible identifying trait selected may be electronic rack depth. In captured image 200 the depth of electronic rack D 100D may not be determinable resulting in the selection of another possible identifying trait to be used.

In block 450, if the possible identifying trait is determinable, method 400 may select the possible identifying trait for use as the visually identifying trait in the comparison. The method may then end in block 490.

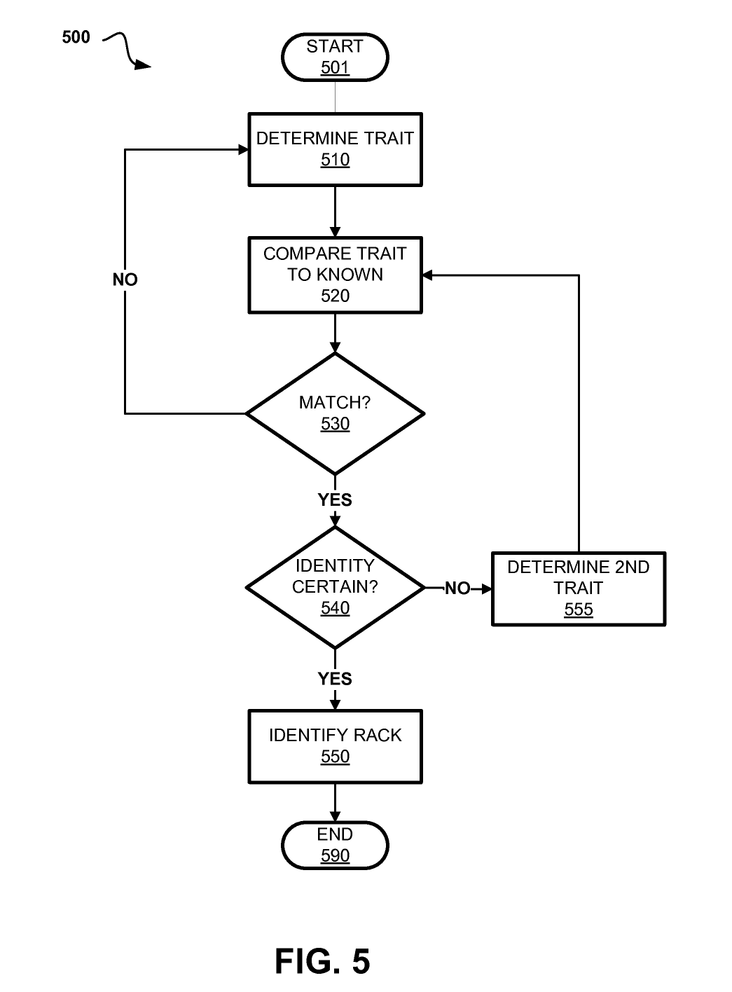

FIG. 5 is a flowchart illustrating a method 500 for comparing and identifying an electronic rack captured in an image, according to an embodiment. Method 500 may start in block 501. In block 510, the visual identifying trait of the captured image, such as captured image 200, to be compared to a known identifying trait of a known rack may be determined. This may be done as shown in FIG. 4 or by other means. In block 520 of FIG. 5, the visual identifying trait of captured image 200 may be compared to a known identifying trait of a known rack in the inventory. In block 530, method 500 may determine if there is a match between the visual identifying trait and the known identifying trait. If no match is found then method 500 may return to block 510 to determine another visually identifying trait to be used in the comparison.

The matching of the visual identifying trait and the known identifying trait in block 530 may differ from the check to see if the trait is determinable in block 430 of FIG. 4. For example, in block 430 it may be found if the color of the rack can be determined, while in block 530 of FIG. 5 it may be found if the determined color matches the color of a known electronic rack.

If a match is found in block 530 method 500 may progress to block 540. In block 540, method 500 may determine if the identification of the rack is certain. Using the example above where the comparison of height H and width W of rack D 110D may reduce or limit to twenty out of three hundred the number of identified electronic racks electronic rack D 110D may be. Thus, it may be that a match in block 530 may not result in certain identification. If the identity is not certain, method 500 may proceed to block 555. In block 555, a second identifying trait may be determined and the method may proceed with the second identifying trait to block 520. In various embodiments, the second identifying trait may be selected based upon matches found in block 530. In other embodiments, the second identifying trait may be selected by predetermined order, user preference, or priority given by the list, database, or application.

If identification is determined certain in block 530 method 500 may progress to block 550. In block 550, method 500 may identify the electronic rack and the method may end in block 590. As previously mentioned, the certainty of identification may not require a complete match between the visual identifying trait and the known identifying trait used.

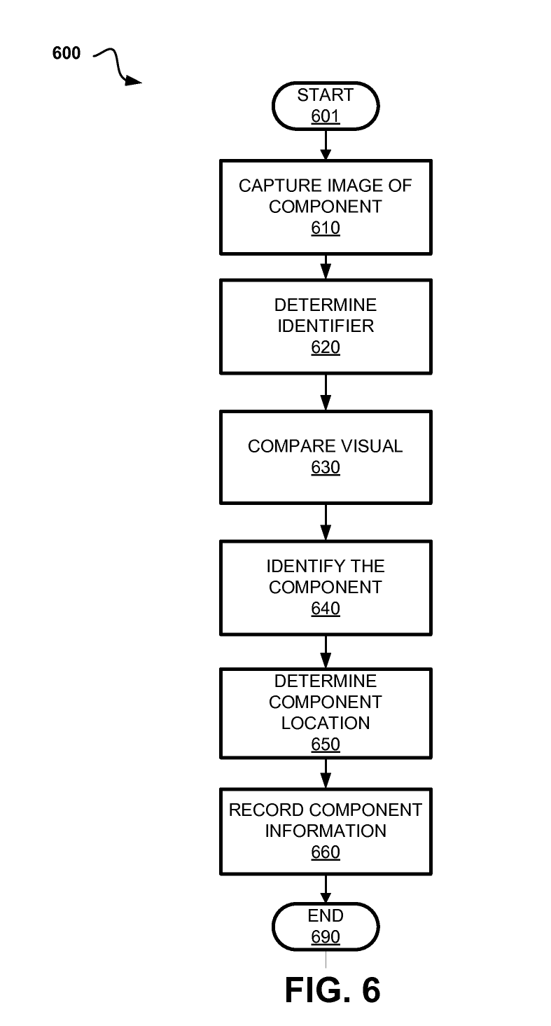

FIG. 6 is a flowchart illustrating a method 600 for determining an identity and location of a component, such as component C 205C in FIG. 2, by remote electronic device 105, according to an embodiment. Method 600 may start at block 601. In block 610, image 200 of electronic rack D 110D and components 205 may be captured. As previously discussed, this may be done by a camera 106 that is part of or in communication with remote electronic device 105.

In block 620, a visually identifying trait may be determined for the captured image 200. This may be done by remote electronic device 105 or software available to remote electronic device 105 through a network and is discussed in greater detail below. In block 630, the previously determined visually identifying trait may be compared to a known identifying trait of a known component identified in the inventory. As previously mentioned, the inventory may be stored in remote electronic device 105 or accessible via a network. In block 640, component C 205C may be identified if the comparison between the visually identifying trait of the captured image 200 is determined to match the known identifying trait of a known electronic rack identified in the inventory. As previously mentioned, the match may not be 100% for the identification to occur and several iterations of the determination and comparing may be done for the identification to be completed.

In block 650, method 600 may determine the location of the component C 205C. In various embodiments, the location may be determined using GPS systems in or available to remote electronic device 105. In other embodiments, the image may be analyzed for visual information of the racks location. This may include, but is not limited to, proximity to other known electronic components, racks, location markers or identifiers in the image or other images available. For example, remote electronic device 105 may use video recordings for capturing images. The video may be analyzed for location information and it may be found that the device was taken into a known room 101 and then turned left before captured image 200 was made. This is exemplary only and a variety of location information and sources is contemplated to be used without departing from the scope of embodiments of the invention.

In block 660, the identity and location of the component C 205C may be recorded. In various embodiments, this may be information updated, recorded, or updated in the inventory. In other embodiments, the location and identity of component C 205C may be recorded to a memory, either part of remote electronic device 105 or remote but available for access by remote electronic device 105. In other embodiments, the information may be recorded to or by an application, software, or database different from the inventory. Method 600 may end in block 390.

In various embodiments, variations of methods 400 and 500 may be used in the identification and location of components. In various embodiments, activities of method 300, 400, 500, or 600 may be eliminated, combined, or more numerous than illustrated.

Embodiments described herein may be in the form of a system, a method, or a computer program product. Accordingly, aspects of embodiments of the invention may take the form of an entirely hardware embodiment, an entirely program embodiment (including firmware, resident programs, micro-code, etc., which are stored in a storage device) or an embodiment combining program and hardware aspects that may all generally be referred to herein as a “circuit,” “module,” or “system.” Further, embodiments of the invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium, may be, for example, but not limited to, an electronic, magnetic, optical, electromagnetic, infrared, or semiconductor system, apparatus, or device, or any suitable combination of the foregoing. More specific examples (an non-exhaustive list) of the computer-readable storage media may comprise: an electrical connection having one or more wires, a portable computer diskette, a hard disk, a random access memory (RAM), a read-only memory (ROM), an erasable programmable read-only memory (EPROM) or Flash memory, an optical fiber, a portable compact disc read-only memory (CD-ROM), an optical storage device, a magnetic storage device, or any suitable combination of the foregoing. In the context of this document, a computer-readable storage medium may be any tangible medium that can contain, or store, a program for use by or in connection with an instruction execution system, apparatus, or device.

A computer-readable signal medium may comprise a propagated data signal with computer-readable program code embodied thereon, for example, in baseband or as part of a carrier wave. Such a propagated signal may take any of a variety of forms, including, but not limited to, electro-magnetic, optical, or any suitable combination thereof A computer-readable signal medium may be any computer-readable medium that is not a computer-readable storage medium and that communicates, propagates, or transports a program for use by, or in connection with, an instruction execution system, apparatus, or device. Program code embodied on a computer-readable medium may be transmitted using any appropriate medium, including but not limited to, wireless, wire line, optical fiber cable, Radio Frequency, or any suitable combination of the foregoing.

Embodiments of the invention may also be delivered as part of a service engagement with a client corporation, nonprofit organization, government entity, or internal organizational structure. Aspects of these embodiments may comprise configuring a computer system to perform, and deploying computing services (e.g., computer-readable code, hardware, and web services) that implement, some or all of the methods described herein. Aspects of these embodiments may also comprise analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention are not limited to use solely in any specific application identified and/or implied by such nomenclature. The exemplary environments are not intended to limit the present invention. Indeed, other alternative hardware and/or program environments may be used without departing from the scope of embodiments of the invention.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope and spirit of the disclosed subject matter.

What is claimed is:

1. A method of determining a location and identity of an electronic rack by a remote electronic device, comprising:
capturing an image of the electronic rack with a camera attached to the remote electronic device;
determining a visual identifying trait of the captured image of the electronic rack;
comparing the visual identifying trait of the captured image of the electronic rack to a known identifying trait of a known electronic rack identified in a first inventory;
identifying the electronic rack based on the comparison of the visual identifying trait of the captured image to the known identified trait;
determining a location of the electronic rack by the remote electronic device; and
recording the location of the identified electronic rack.

2. The method of claim 1, further comprising:
determining a second visual identifying trait of a component in the captured image of the electronic rack;
comparing the second visual identifying trait to a second known identifying trait of a known component identified in a second inventory;
identifying the component based on the comparison of the second visual identifying trait to the second known identifying trait;
determining a location of an identified component by the remote electronic device; and
recording the location of the identified component.

3. The method of claim 2, further comprising:
updating the inventory with the location of the identified component.

4. The method of claim 2, wherein the second visual identifying trait is a light emitting element being lit.

5. The method of claim 4, wherein the lighting of the light emitting element is controlled by the remote electronic device.

6. The method of claim 2, further comprising:
providing a component information of the identified component to a user.

7. The method of claim 1, further comprising:
providing a rack information of the identified rack to a user.

8. The method of claim 1, further comprising:
updating the inventory with the location of the identified electronic rack.

9. The method of claim 1, wherein the visual identifying trait is a light emitting element being lit.

10. The method of claim 9, wherein the lighting of the light emitting element is controlled by the remote electronic device.

11. A computer program product comprising a computer readable storage medium having program code embodied therewith, the program code executable by a computer system to determining a location and identity of an electronic rack by a remote electronic device, comprising:
capturing an image of the electronic rack with a camera attached to the remote electronic device;
determining a visual identifying trait of the captured image of the electronic rack;
comparing the visual identifying trait of the captured image of the electronic rack to a known identifying trait of a known electronic rack identified in a first inventory;
identifying the electronic rack based on the comparison of the visual identifying trait of the captured image to the known identified trait;
determining a location of the electronic rack by the remote electronic device; and
recording the location of the identified electronic rack.

12. The computer program product of claim 11, further comprising:
determining a second visual identifying trait of a component in the captured image of the electronic rack;
comparing the second visual identifying trait to a second known identifying trait of a known component identified in a second inventory;
identifying the component based on the comparison of the second visual identifying trait to the second known identifying trait;
determining a location of an identified component by the remote electronic device; and
recording the location of the identified component.

13. The computer program product of claim 11, further comprising:
updating the inventory with the location of the identified component.

14. The computer program product of claim 11, wherein the visual identifying trait is a light emitting element being lit.

15. The computer program product of claim 14, wherein the lighting of the light emitting element is controlled by the remote electronic device.

16. The computer program product of claim 11, further comprising:
providing a component information to a user.

17. The computer program product of claim 11, further comprising:
providing a rack information to a user.

18. The computer program product of claim 11, further comprising:
updating the inventory with the location of the identified electronic rack.

19. The computer program product of claim 11, wherein the visual identifying trait is a light emitting element being lit.

20. The computer program product 19, wherein the lighting of the light emitting element is controlled by the remote electronic device.
